(19) United States
(12) Patent Application Publication
(10) Pub. No.: US 2025/0289165 A1
(43) Pub. Date: Sep. 18, 2025

(54) A METHOD OF RECOVERY OF POLYOLEFINS FROM WASTE MATERIALS, AND POLYOLEFIN PRODUCT SO RECOVERED

(71) Applicant: Sabanci Üniversitesi, Tuzla/Istanbul (TR)

(72) Inventors: Serkan UNAL, Tuzla/Istanbul (TR); Nuray KIZILDAG, Tuzla/Istanbul (TR); Serkan GUCLU, Tuzla/Istanbul (TR)

(21) Appl. No.: 18/860,289

(22) PCT Filed: Apr. 26, 2022
(86) PCT No.: PCT/TR2022/050375

§ 371 Date: Oct. 25, 2024

(51) Int. Cl. B29B 17/02; B29K 23/00; C08J 11/08

(52) U.S. Cl. CPC B29B 17/02; C08J 11/08; B29B 2017/0289; B29B 2017/0293; B29K 2023/00; C08J 2323/00

(57) ABSTRACT

Method for selectively extracting and recovering pure polyolefin polymers from wastes containing a plurality of polymers, by using one or more solvents at different temperatures for selectively dissolving one or more polymers from the mixture. Generally it is presented a vegetable oil-based recycling method basically comprising the three main steps as extraction of waste polyolefins from mixed waste by dissolving in vegetable oil, advanced purification of polyolefins using sequential filters with progressively decreasing pore sizes in each filter, and precipitation of the selected and/or purified polyolefins in a liquid that is miscible with the vegetable oil. Further provided is a polyolefin product with a purity of greater than 99% as recovered by the method.

### TECHNICAL FIELD OF THE INVENTION

The present invention relates to a method for recycling polyolefins from waste products including polypropylene, polyethylene, copolymers and mixtures thereof. The present invention generally relates to using vegetable oils and their mixtures for dissolving, dissolving via melting, selectively dissolving polyolefins, and their extraction and recovery from the multicomponent plastic waste or plastic waste mixtures.

### BACKGROUND OF THE INVENTION

The need for plastic recycling is increasing with the rising environmental concerns and the rising importance of circular economy. In this regard, compared to other methods, plastic recycling by solvent-based extraction is gaining importance as it has been successful in the extraction of selected polymers from mixed plastic waste and provides recycled polymers in higher purity compared to conventional mechanical recycling methods. This solvent-based extraction method generally comprises the dissolution of the collected material in a solvent, filtration for the removal of impurities, precipitation of the polymer, separation of the recovered polymer, thorough washing, and drying.

However, many problems arise in the solvent-based extraction process. Many of the chemicals used to dissolve plastics are harmful to the environment and living organisms, which is a very important obstacle to the widespread use of this recycling method. Most of the solvents used are petroleum-based with high carbon footprint and cost. Another disadvantage of the process is that the presence of residual solvent in the recycled polymers, although a little, limits the reuse of these obtained polymers in many applications, which leads to a decrease in its worth and price.

A prior art JP2002003860A discloses an apparatus and a method for converting waste plastics into oil/fuel by melting the waste plastics in vegetable oil. According to said patent application, the plastic from mixed household waste is dissolved in solvent oil like edible oil, vegetable oil and mineral oil for dehydration, dechlorination, and enhancing the calorific value of plastic.

Another prior art, WO9909092A1, discloses a method for reprocessing polymeric products, for example tyres and PVC coated metal products, wherein the process includes the step of treating the polymeric product with at least one vegetable oil, and subjecting the vegetable oil in contact with the polymeric product to an elevated temperature for a sufficient time to liquify the polymer. The liquified polymer is then separated from the metals and canvas/belting products in the polymeric product in order to recover the polymer, metals, and canvas/belting products.

As reported above, there are studies in the literature on the use of vegetable oils in plastic recycling, but until now, there is no method that provides virgin-like quality and purified polymers and offers a solution for the removal of residual solvent in the recycled polymer structure.

It is essential to employ more environmentally friendly, non-toxic, more economically, and greener solvents and develop plastic recycling methods using these solvents.

### OBJECTS OF THE INVENTION

The primary object of the present invention is to overcome the abovementioned shortcomings of the prior art.

A further object of the invention is to develop an effective recycling method that can extract polyolefins in their pure form from mixed wastes and enables the use of vegetable oils as solvents.

It is still a further object of this invention to provide a method allowing vegetable oils to be used as polyolefin solvents which are more economical, renewable, and environmentally friendly in comparison to currently employed solvents in chemical and/or solvent-based recycling and purification of plastics.

Another object of the present invention is to provide a method for extracting polyolefins from multicomponent plastic waste or plastic waste mixture using vegetable oils as the solvent and alkanes as the nonsolvent.

Another object of the present invention is to provide a method with optimum precipitation conditions to minimize the amount of residual oil in the extracted polyolefin.

Another object of the present invention is to provide a method with optimum temperature for the processability and separability of each polyolefin type.

Another object of the present invention is to provide a method for recycling coated polyolefin packaging films (metallic, poly (vinyl alcohol), poly (vinylidene chloride), etc. coated) using vegetable oil as the solvent and alkanes as the nonsolvent.

Another object of the present invention is to replace the solvents currently used, petroleum-based decalin, tetrachloroethylene, xylene, toluene/petroleum ether or any other solvents with environmentally benign vegetable oils.

Other objects of the present invention will become apparent from accompanying drawings, brief descriptions, which follow in the next section as well as appended claims.

### SUMMARY OF THE INVENTION

The present invention provides a method for selectively extracting and recovering pure polyolefin polymers from wastes containing a plurality of polymers, by using one or more solvents at different temperatures for selectively dissolving one or more polymers from the mixture. The present invention generally presents a vegetable oil-based recycling method basically comprising the three main steps as extraction of waste polyolefins from mixed waste by dissolving in vegetable oil, advanced purification of polyolefins using sequential filters by progressively decreasing pore sizes in each filter, and precipitation of the selected and/or purified polyolefins in a liquid that is miscible with the vegetable oil.

A method for the extraction and recovery of polyolefins from waste mixture essentially comprising the step of (i) mixing the waste material into a vegetable oil, selectively extracting polyolefins from mixed waste by heating at a certain temperature depending on the polyolefin type, (ii) separation of undissolved materials from the solution by filtration through a coarse filter, (iii) purification of the filtered mixture including the dissolved polyolefin by a fine filter while maintaining its initial temperature, (iv) precipitation of the purified mixture in a liquid which is miscible with said vegetable oil and does not dissolve the said polyolefin at said precipitation conditions, (v) separation of precipitated polyolefin from the vegetable oil/nonsolvent mixture, (vi) thoroughly washing the precipitated polyolefin to purify and remove remaining oils, (vii) drying the separated polyolefin, (viii) separation of the vegetable oil/nonsolvent mixture via distillation, with the recovered nonsolvent retrieved from the top of a distillation column and the recovered vegetable oil retrieved from the bottom of said distillation vessel.

Another aspect of the said recycling method provides high purity polyolefins from mixed materials using vegetable oils as solvent. This method includes the following steps: selectively dissolving polyolefins in plastic waste mixtures using vegetable oils as the solvent, performing advanced purification of polyolefins using sequential filters by progressively decreasing pore sizes in each filter, separation of vegetable oil from filtered and purified polyolefins via precipitation of filtered and purified solution in the presence of a nonsolvent that dissolves vegetable oil, separation and thoroughly washing of precipitates, drying of recycled polymers.

In a possible embodiment, the vegetable oil/nonsolvent ratio used in precipitation step is greater than 1:1 (v/v) and preferably greater than 1:3 (v/v).

In a possible embodiment, the waste mixture concentration in the vegetable oil is ranging from 5 to 30% by weight.

In a possible embodiment, the waste mixture comprises polyethylene and polypropylene together, and the waste mixture is mixed into a vegetable oil by heating at a temperature ranging from 140 to 155° C. to selectively dissolve and recover polyethylene from the mixture first according to the abovementioned steps, and then re-mixing the unfiltered portion into a vegetable oil again and heating up to 185° C. to dissolve and recover polypropylene according to the abovementioned steps.

In a possible embodiment, polyolefin product(s) with a purity of greater than 99% is recovered in accordance with said method.

In a possible embodiment, polyolefin product(s) with a residual solvent of lower than 1% is recovered in accordance with said method.

In a possible embodiment, polyolefin product(s) with a nonsolvent content of lower than 1% recovered in accordance with said method.

### BRIEF DESCRIPTION OF THE FIGURES

FIGS. 1 and 2 show FTIR spectra of canola oil, waste carpet material, coarse filter waste, pure polypropylene and recycled polypropylene polymer according to example 1.

FIGS. 3 and 4 show FTIR spectra of recycled polyethylene in comparison to pure polyethylene and recycled polypropylene in comparison to pure polypropylene according to example 2.

FIGS. 5, 6 and 7 show FTIR spectra of recycled polypropylene precipitated in heptane at 7, 24, and 98° C. according to example 3.

FIG. 8 shows a FTIR spectra of recycled polypropylene, precipitated in heptane at 98° C. varying the solvent to nonsolvent ratios according to example 4.

### DETAILED DESCRIPTION OF THE INVENTION

A method for the recovery of polyolefins from a waste material comprising the step of mixing the waste material into a vegetable oil and heating at a temperature ranging from 120° C. to 200° C. for obtaining a mixture containing dissolved polyolefin, filtering the mixture by a coarse filter, purification of the filtered mixture including dissolved polyolefin by further filtration through a second filter, precipitation of the purified polyolefin by adding filtered mixture at its initial temperature into a liquid which is a nonsolvent that is miscible with said vegetable oil, at or below the boiling point of the nonsolvent, separation of precipitated solid polyolefin from the vegetable oil/nonsolvent mixture, washing the separated polyolefin with the nonsolvent, and drying under the inert atmosphere.

In accordance with an embodiment of the invention, the method further comprises a step of fractionation of the vegetable oil/nonsolvent mixture via distillation, with the recovered non-solvent retrieved from a distillation column and the recovered vegetable oil retrieved from the bottom of said distillation setup.

In accordance with an embodiment of the invention, the first coarse filter has a pore size ranging from 5 to 40 μm. In accordance with an embodiment of the invention, the second filter has a pore size ranging from 100 nm to 450 nm.

In accordance with an embodiment of the invention, the method further comprises a step of passing the filtered mixture through an adsorption column such as activated carbon column.

In accordance with an embodiment of the invention, with a two-stage filtration, the impurities in the resulting mixture are removed. First, if there are non-polyolefin and vegetable oil-insoluble substances in the mixture, these insoluble substances are removed by a coarse filtration. An average pore size of 5 micron and above is sufficient for coarse filtration, preferably 37 micron (400 mesh). In order to remove the remaining fillers, pigments and various additives in the solution containing the dissolved part of input material, a second filtration is required using a filter with an average pore size of 1 micron and below, preferably 0.1 micron.

In accordance with an embodiment of the invention, the method further comprises a step of washing the resultant polyolefin in boiling nonsolvent under reflux when it is precipitated in heptane at a temperature ranging from 20° C. to 30° C. between the step (iv) and the step (vi).

In accordance with another embodiment of the invention, the method further comprises a step of washing the resultant polyolefin in boiling heptane under reflux when it is precipitated in heptane at a temperature ranging from 22° C. to 37° C. between the step (iv) and the step (vi).

In accordance with an embodiment of the invention, the input waste material may be any organic and inorganic mixture containing polyolefins, preferably at least 30% polyolefin. In accordance with an embodiment of the invention said polyolefin is a polypropylene or polyethylene, copolymer or combination thereof.

In accordance with an embodiment of the invention, said vegetable oil is a form of triglycerides which is an ester formed by the addition of three fatty acids to glycerol. Soybean oil, grape seed oil, and cocoa butter are examples of fats from seeds. Olive oil, palm oil, and rice bran oil are examples of fats from other parts of fruits. Another aspect of the invention said vegetable oil can be selected from the list comprising canola oil, sunflower oil, cottonseed oil, corn, olive, peanut, and coconut oil or a combination of two or more thereof.

According to said invention, dissolution and polyolefin extraction temperatures are 140° C. and above, preferably 155° C., for wastes containing only polyethylene type polyolefin, and 170° C. and above, preferably 185° C., for wastes containing only polypropylene type polyolefin. In case of a combination of polyethylene and polypropylene type polyolefins in same waste mixture, extraction of the polyethylene first at 155° C., followed by the extraction of the remaining polypropylene at 185° C.

In a possible embodiment, the nonsolvent is an alkane and preferably an aliphatic or cyclic saturated hydrocarbon, with a number of carbon atoms equal to 6 to 9. Alternatively, said nonsolvent an aliphatic or cyclic saturated hydrocarbon, with a number of carbon atoms higher than 6. In another exemplary embodiment, the aliphatic or cyclic saturated hydrocarbon comprises seven carbon atoms with one chiral carbon atom. In a preferred embodiment, the nonsolvent is heptane, hexane, or cyclohexane.

According to said invention, the vegetable oil/nonsolvent ratio used in precipitation step is greater than 1:1 (v/v) and preferably greater than 1:3 (v/v). In accordance with said embodiment the waste mixture including the polyolefin was in a concentration ranging from 5 to 30% by weight in the recycling solvent.

According to said invention, the precipitation of the polyolefin to be recovered is carried out by dripping hot solution into nonsolvent at or slightly below its boiling point temperature. For example, if heptane is used as a nonsolvent, the precipitation temperature will be 98° C. or below. When the precipitation is conducted at lower temperatures, the amount of residual solvent trapped in the recovered polyolefin increases.

In accordance with an embodiment of the invention, when the polyolefins are separated from the mixture formed after precipitation, some solvent may remain in and on the surface of polyolefin particles and they may be washed and rinsed well with the nonsolvent to remove.

According to said invention, the drying process is carried out under inert atmosphere, optionally under heat and/or vacuum to reduce the risk of oxidation by removing the oxygen from the environment and to ensure better removal of the nonsolvent.

### Example 1: Extraction and Recovery of High Purity Polypropylene from Waste Carpet

A waste carpet comprising cotton, wool, jute, PAN, PET, PU and SBR was shredded into small pieces. Recycling process of the polypropylene in said waste carpet includes a dissolution step, hot coarse filtration followed by hot fine filtration, precipitation step, separation of precipitated polypropylene, thorough washing, and drying.

In dissolution step, required amount of pre-processed feedstock material was placed into the canola oil. The mixture was stirred by a magnetic stirrer at 185° C. for 2 hours under reflux. In filtration step, two stage filtration was applied for the removal of impurities (coarse undissolved materials and pigments, respectively). A stainless steel mesh with a mesh pore size of 37 μm was used as a coarse filter to remove coarse undissolved materials. A filtration cell with an active filtration area of 14.6 cm² was used for the hot fine filtration. The filtration cell was wrapped by a flexible heating tape and heated to 190° C. before filtration. A PTFE membrane with a pore size of 0.2 μm was used for the removal of the pigments in the filtration cell. The solution was filtered directly into the heptane for precipitation. The pigments were captured by the PTFE membrane during the hot filtration and polypropylene polymer free from pigments precipitated in the heptane. For the precipitation, canola oil to nonsolvent ratio was selected as 1:3 v/v. The waste carpet/canola solution was filtered through the membrane into the heptane at 98° C. After that, separation of recovered polypropylene from the solvent/nonsolvent mixture was carried out. Precipitated polypropylene grains were isolated from canola and heptane mixture. Then the recycled polypropylene polymer obtained was thoroughly washed and then dried in an oven at 50° C. under vacuum (50 mbar) for 5 hours. For the separation of solvent/nonsolvent mixture, the solvent/nonsolvent mixture was separated at the end of the process by a rotary evaporator for reuse and efficiency of the process in terms of solvent recovery was evaluated. The amount of canola oil used in the dissolution process is 88.76 ml, the amount of recovered canola oil is 87.04 ml, and the recovery efficiency is 98.06%. The amount of heptane used in the precipitation process is 577.49 ml, the amount of recovered heptane is 421.13 ml, and the recovery efficiency is 78.12%. The amount of polypropylene in the waste is 80.75%, the amount of recovered polypropylene is 76.37%, and the recovery efficiency is 95%.

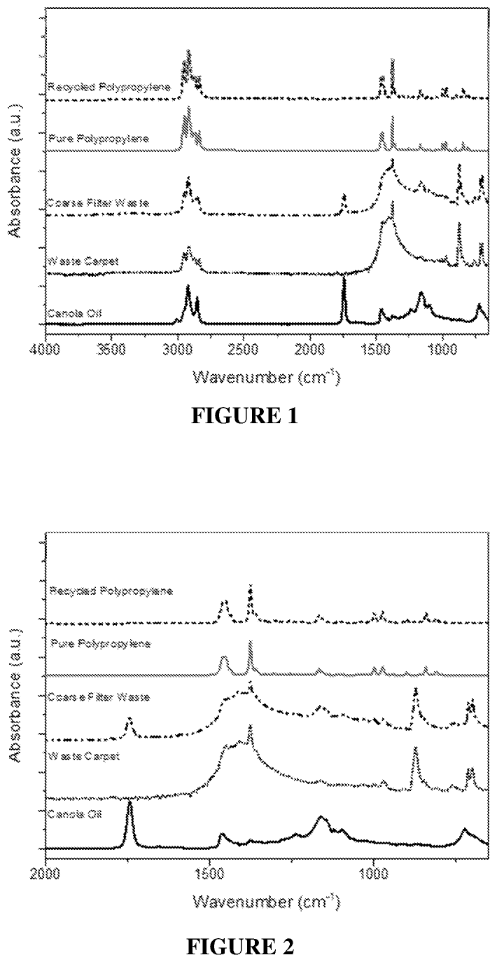

A spectrometer was used for FTIR analysis of canola oil, waste carpet material, coarse filter waste, pure polypropylene and recycled polypropylene polymer in order to confirm that the recycled polypropylene obtained via the solvent-based recycling using canola oil as the solvent showed similar structure and composition to the pure polypropylene freshly synthesized from petroleum-based products. A minimum of 32 scans with a signal resolution of 4 cm⁻¹ within the 4000-650 cm⁻¹ range were averaged to obtain the spectra. The FTIR spectra obtained are presented in FIG. 1 and FIG. 2.

In the FTIR spectrum of pure polypropylene pellets, peaks at 2950 cm⁻¹, 2917 cm⁻¹, 2866 cm⁻¹ and 2838 cm⁻¹ referred to C-H stretchings. While the strong peak located at 1376 cm⁻¹referred to CH₃ in-the-plane bending, the single rounded peak at 1452 cm⁻¹ corresponded to C-H asymmetric deformation vibrations of isolated—CH₂ in homopolymer polypropylene. Peaks at 1167 cm⁻¹, 998 cm⁻¹, 842 cm⁻¹ can be assigned to characteristic vibrations for isotactic polypropylene polymer.

Although it was not possible to precisely identify the chemical composition of the carpet waste, and coarse filter waste because of the mixed nature of these materials, the peaks observed between 600 and 1750 cm⁻¹ for the waste carpet, which were assigned to the pigments, additives, and impurities disappeared in the spectrum of recycled polypropylene polymer, which showed that the pigments and additives were removed successfully by the sequential filtration applied. Characteristic peaks of pure polypropylene were mainly observed in the FTIR spectrum of the recycled polypropylene. Additionally, FTIR spectrum of recycled polypropylene polymer confirmed that recycled polypropylene was free from the solvent (canola oil) as signals of the canola oil, mainly the peak at 1742 cm⁻¹ corresponding to carbonyl peak, were not observed in the spectrum of the recycled polypropylene polymer.

### Example 2: Selective Dissolution and Recovery of Polymers From Polypropylene and Polyethylene Mixture Using Canola Oil as the Solvent and Heptane as The Nonsolvent

The present invention provides a method for recovering both polyethylene and polypropylene from a mixture of plastics. Since the waste contains both polyethylene and polypropylene, the polyethylene is first dissolved in vegetable oil at 155° C., and the insoluble polypropylene is filtered off. The aforementioned processes are used to recover dissolved polypropylene wherein said process comprises advanced purification of polyethylene using sequential filters by progressively decreasing pore sizes in each filter, separation of vegetable oil from filtered and purified polyethylene via precipitation of filtered and purified solution into heptane that dissolves vegetable oil, separation and thoroughly washing of precipitates, and drying of recycled polyethylene. After that, the residual waste that does not contain polyethylene is dissolved in canola oil by heating at 185° C. for the recovery of polypropylene. Following the dissolution of the polypropylene, the procedures of filtering, precipitation, separation, washing, and drying are performed throughout the polypropylene recovery process.

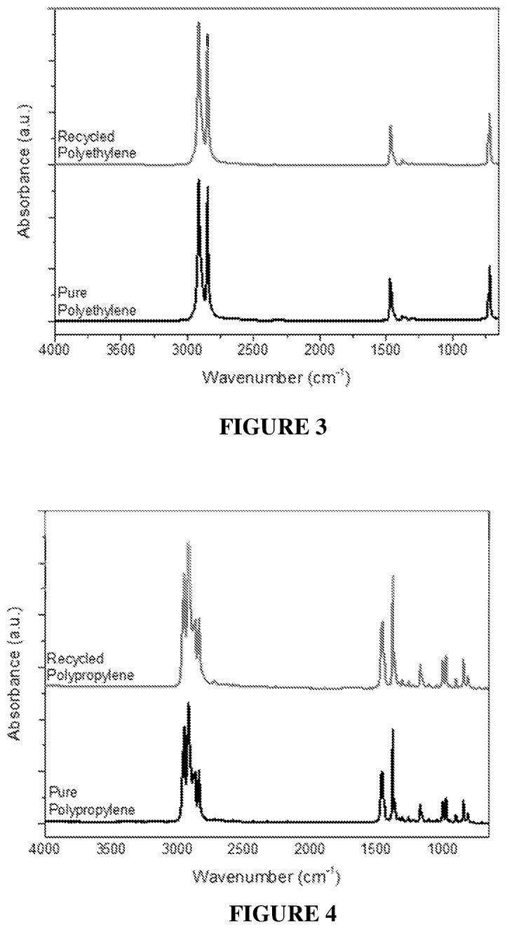

Polyethylene and polypropylene are rather simple in their chemical nature, consisting of only carbon and hydrogen atoms linked by covalent bonds, resulting in a small number of signals in FTIR spectrum as seen in FIG. 3 and FIG. 4. In the FTIR spectrum of pure polyethylene characteristic peaks located at 2919 cm⁻¹, 2850 cm⁻¹, 1470 cm⁻¹, and 718 cm⁻¹ are observed. While the peaks at 2919 and 2850 cm⁻¹ are assigned to—CH₂ asymmetric and symmetric stretchings, respectively; the peak at 1464 corresponds to the bending vibration of—CH₂ and 730 cm⁻¹ to—CH₂ rocking. The peaks observed in the spectrum of the recycled polyethylene were identical to the characteristic peaks of pure polyethylene which showed that the recycled polyethylene obtained by the recycling process applied was the same as the pure polyethylene and in pure state (free from polypropylene and vegetable oil used). Referring to FIG. 3 and FIG. 4, in the FTIR spectrum of pure polypropylene pellets, peaks at 2950 cm⁻¹, 2917 cm⁻¹, 2866 cm⁻¹ and 2838 cm⁻¹ referred to C-H stretchings. While the strong peak located at 1376 cm⁻¹ referred to CH₃ in-the-plane bending, the single rounded peak at 1452 cm⁻¹ corresponded to C-H asymmetric deformation vibrations of isolated—CH₂ in homopolymer polypropylene. Peaks at 1167 cm⁻¹, 998 cm⁻¹, 842 cm⁻¹ were assigned to characteristic vibrations for isotactic polypropylene. The peaks observed in the spectrum of the recycled polypropylene were identical to the characteristic peaks of pure polypropylene which showed that the recycled polypropylene obtained by the recycling process applied were the same as the pure polypropylene and in pure state (free from polyethylene and vegetable oil used).

### Example 3: Precipitation of Extracted Polypropylene at Different Nonsolvent Temperatures

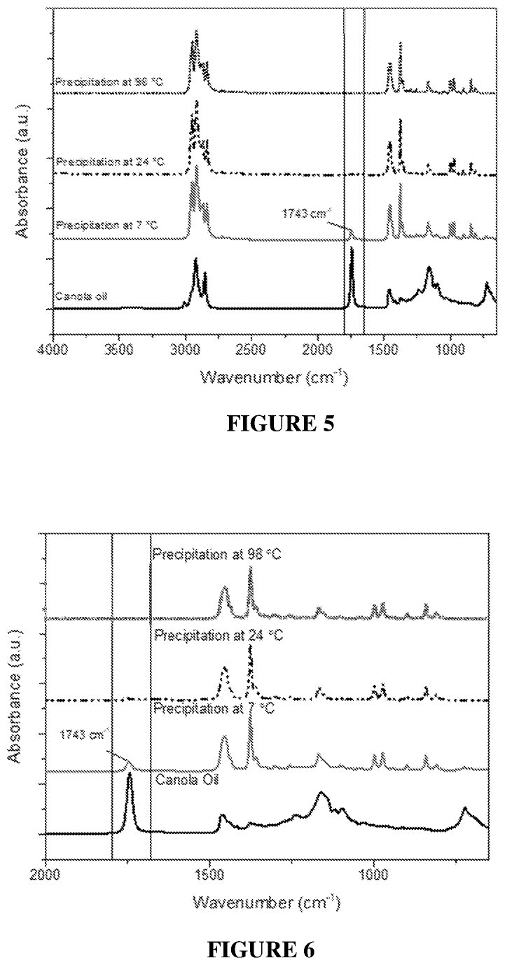

Pure polypropylene pellets were dissolved in canola oil at a ratio of 5% (w/v) at 185° C. The obtained solutions were dripped into the heptane at 7° C., 24° C. and 98° C. to precipitate the polypropylene. Canola oil/heptane ratio was 1:3 (v/v) in said experiments. When the hot mixture was poured into heptane at its boiling point, the mixture was clear and transparent at first. But when it was cooled down slowly and the temperature approached 80° C., the solution started to become cloudy as the polypropylene started to solidify slowly. As the temperature of the mixture decreased below approximately 80° C., this cloudy state became more evident. However, when the same hot solution was poured into heptane at 24° C., the final temperature of the mixture did not exceed 65° C. and precipitation was observed as soon as the solution was poured. Likewise, immediate precipitation was observed when the hot solution was poured into heptane at 7° C. When the initial temperature of the heptane was at room temperature or lower in separate precipitation trials, the obtained polypropylene products had yellowish color indicating a higher content of trapped canola oil. This was also confirmed by the FTIR analysis as seen in FIGS. 5, 6 and 7. While the peak at 1743 cm⁻¹ was visible on the spectrum of the recycled polypropylene polymer precipitated at 7° C. showing the presence of trapped canola oil in the polymer, it decreased at polypropylene sample obtained at precipitation temperature of 24° C. and completely disappeared at polypropylene sample obtained at precipitation temperature of 98° C. It can be concluded that the residual solvent (canola oil) remaining in the recovered polypropylene product decreased by the slow solidification and crystallization that occurred when the precipitation was conducted using preheated heptane (up to 98° C.). This is an important step to reduce residual solvent in the final polypropylene product.

### Example 4: Precipitation of Dissolved Polypropylene in Various Solvent-Nonsolvent Ratios

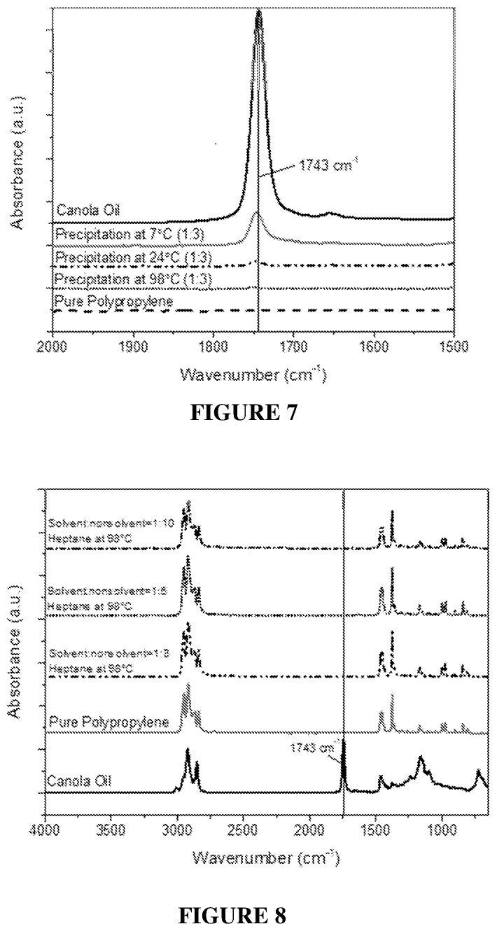

Pure polypropylene pellets were dissolved in canola oil in a ratio of 5% (w/v) at 185° C. The obtained solutions were dripped into the heptane at 98° C. in three separate experiments performed varying the solvent to nonsolvent ratios as 1:3, 1:5 and 1:10 (v/v). The FTIR spectrum of the recycled polypropylene polymers obtained varying the solvent to nonsolvent ratios showed no signs of residual canola oil (the peak at 1743 cm⁻¹ was not visible) as seen in FIG. 8.

### Example 5: Washing the Final Polypropylene in Boiling Heptane Under Reflux

Pure polypropylene pellets were dissolved in canola oil at a ratio of 5% (w/v) at 185° C. The obtained solutions were dripped into the heptane at 24° C. to precipitate the polypropylene. Resultant polypropylene was washed in boiling heptane under reflux for 2 hours. It was observed that the initial state of the polypropylene was more yellowish than the polypropylene washed under these conditions. Washing in boiling heptane under reflux extracted and removed the remaining residual canola oil from the polypropylene polymer.

The claimed invention comprising a method and/or a solvent-nonsolvent combination brings the advantages of:
conserving landfill space that is rapidly decreasing
reducing demand for fossil fuels
processing plastic-based waste that is not homogeneous
offering recovering performance while being environmentally conscious
providing an economical and environmentally way for recovery of carpeting materials
separating a plurality of incompatible polymers from a mixture of the polymers

1. A method for the recovery of polyolefins from waste materials comprising the steps of:
i. mixing the waste material into a vegetable oil and heating at a temperature ranging from 120° C. to 200° C. for obtaining a mixture containing dissolved polyolefin,
ii. filtering the mixture by a coarse filter,
iii. purification of the filtered mixture including dissolved polyolefin by further filtration through a second filter,
iv. precipitation of the purified polyolefin by adding filtered mixture at its initial temperature into a liquid which is a nonsolvent that is miscible with said vegetable oil, at or below the boiling point of the nonsolvent,
v. separation of precipitated solid polyolefin from the vegetable oil/nonsolvent mixture,
vi. washing the separated polyolefin with the nonsolvent and drying under the inert atmosphere.

2. The method according to claim 1, further comprising a step of fractionation of the vegetable oil/non-solvent mixture via distillation, with the recovered nonsolvent retrieved from a distillation column and the recovered vegetable oil retrieved from the bottom of said distillation column.

3. The method according to claim 1 or 2 further comprising, between the step (iv) and the step (vi), (iv′) a step of washing the resultant polyolefin in the boiling nonsolvent under reflux when the purified polyolefin solution precipitates in the nonsolvent at a temperature ranging from 20° C. to 30° C.

4. The method according to claim 1 or 2, further comprising, between the step (iv) and the step (vi), (iv′) a step of washing the resultant polyolefin in boiling heptane under reflux when the purified polyolefin solution precipitated in heptane at a temperature ranging from 22° C. to 27° C.

5. The method according to claim 1, further comprising, between the step (iii) and the step (iv), (iii′) a step of passing the filtered mixture through an adsorption column.

6. The method according to claim 5, wherein the adsorption column is an activated carbon column.

7. The method according to any of the preceding claims 1 to 6, wherein the coarse filter has a pore size ranging from 5 to 40 μm.

8. The method according to any of the preceding claims 1 to 7, wherein the second filter has a pore size ranging from 100 nm to 450 nm.

9. The method according to any of the preceding claims 1 to 8, wherein the separated polyolefin from the nonsolvent is dried at a temperature ranging from 30° C. to 60° C.

10. The method according to any of the preceding claims 1 to 9, wherein said vegetable oil is selected from canola oil, sunflower oil, olive oil, coconut oil, cottonseed oil, a combination of two or more thereof.

11. The method according to any of the preceding claims 1 to 10, wherein said polyolefin is a polypropylene, polyethylene, copolymers or a combination thereof.

12. The method according to any of the preceding claims 1 to 11, wherein said nonsolvent is an aliphatic or cyclic saturated hydrocarbon, with a number of carbon atoms equal to 5.

13. The method according to any of the preceding claims 1 to 11, wherein said nonsolvent an aliphatic or cyclic saturated hydrocarbon, with a number of carbon atoms higher than 6.

14. The method according to any of the preceding claims 1 to 11, wherein the aliphatic or cyclic saturated hydrocarbon comprises seven carbon atoms with one chiral carbon atom.

15. The method according to any of the preceding claims 1 to 11, wherein the nonsolvent is heptane, hexane, or cyclohexane.

16. The method according to any of the preceding claims 1 to 15, wherein vegetable oil/nonsolvent ratio used precipitation step is greater than 1:1 (v/v) and preferably greater than 1:3 (v/v).

17. The method according to any of the preceding claims 1 to 16, wherein the waste material concentration in the vegetable oil is ranging from 5 to 30% by weight.

18. The method according to any of the preceding claims 1 to 17, wherein the waste material comprises polyethylene and polypropylene together, and the waste mixture is mixed into a vegetable oil by heating at a temperature ranging from 140 to 155° C. to selectively dissolve and recover polyethylene from the mixture first, and then increasing the temperature to 185° C. to dissolve and recover polypropylene.

19. Polyolefin product(s) with a purity of greater than 99% recovered according to preceding claims.

20. Polyolefin product(s) with a nonsolvent content of lower than 1% recovered according to preceding claims.
